(19) United States
(12) Patent Application Publication
(10) Pub. No.: US 2003/0009515 A1
(43) Pub. Date: Jan. 9, 2003

(54) System and method for networking home appliances through multinetwork structure

(76) Inventors: Sang Kyun Lee, Kwangmyung-si (KR); Ki Tae Oh, Kwangmyung-si (KR); Yeon Kyung Lee, Koyang-si (KR); Chang Ho Kim, Seoul (KR)

Correspondence Address: BIRCH STEWART KOLASCH & BIRCH, PO BOX 747, FALLS CHURCH, VA, 22040-0747, US

(21) Appl. No.: 10/124,347

(22) Filed: Apr. 18, 2002

(30) Foreign Application Priority Data
May 2, 2001 (KR) 2001-23865

(51) Int. Cl. G06F 15/16

(52) U.S. Cl. 709/202

(57) ABSTRACT

A system and method for networking home appliances through a multinetwork structure, wherein the home appliances are connected directly or indirectly to a network constructed through a LAN line or power line communication network in a home such that they are operated according to algorithms of different coding/decoding levels. The home appliances construct different networks so that they are efficiently interoperable in the entire network. Therefore, even though an external intruder intrudes into any one of the different networks, information of home appliances connected to the other networks can be prevented from leaking out, thereby avoiding security risks.

### BACKGROUND OF THE INVENTION

1. Field of the Invention

The present invention relates to systems and methods for networking home appliances, and more particularly to a system and method for networking home appliances through a multinetwork structure, wherein the home appliances are interconnected via a network constructed in a home and are efficiently interoperable over multiple networks.

2. Description of the Related Art

A home appliance networking system has recently been highlighted in which a plurality of home appliances are interconnected via an internal network of a home and the internal network is connected to an external Internet network, thereby enabling a user to control the home appliances from anywhere inside and outside of the home.

In the home appliance networking system, particularly, the user can not only recognize state information of a specific home appliance at any place inside of the home, but also control the specific home appliance using control means, such as a computer, from any place outside of the home. In this regard, the home appliance networking system has obtained favorable responses from many consumers, and thus becomes more widespread in its application day by day.

FIG. 1 shows the construction of a conventional home appliance networking system.

As shown in FIG. 1, home appliances, such as a washing machine, refrigerator, TV, etc., are connected to a network constructed in a home through a power line or local area network (LAN) line such that they exchange data with one another in a P2P (Peer-to-Peer) manner. As needed, the power line or LAN line is connected to the Internet to enable a user to control the home appliances over an external Internet network.

The transmission and reception of data among the home appliances in the P2P manner must be performed according to a predefined algorithm. However, it is very complex to determine an algorithm appropriate for management, arrangement and transmission/reception of data among the home appliances.

In particular, in the case where a plurality of home appliances are interconnected to transmit and receive data, a complex algorithm must be employed to resolve a data collision or perform data priority assignment for prevention thereof. However, it is very hard to propose such an algorithm, and, even though it is proposed, a great cost and a large amount of time are required in manufacturing home appliances in such a way that they are operated according to the proposed algorithm.

Furthermore, a home appliance transmitting a control command to a peripheral device, such as an audio receiver, and a home appliance operated according to a transmitted control command, such as a CD player, TV, coffeepot, air-conditioner or the like, cannot be operated according to the same algorithm and at the same coding/decoding levels. For this reason, it is the current reality that a plurality of home appliances are not interoperable when they are interconnected directly via a network.

Besides, in the case where an external intruder gains access to a single network under the condition that a plurality of home appliances are interoperable over the single network, information regarding all the plurality of home appliances shared on the network may leak out. That is, security risks exist.

### SUMMARY OF THE INVENTION

Therefore, the present invention has been made in view of the above problems, and it is an object of the present invention to provide a system and method for networking home appliances through a multinetwork structure, wherein the home appliances are connected directly or indirectly to a network constructed in a home such that they are interoperable to exchange control information and state information with one another, and security risks, such as an information leakage over the network, are avoided.

In accordance with one aspect of the present invention, the above and other objects can be accomplished by the provision of a system for networking home appliances through a multinetwork structure, comprising: at least one direct home appliance connected directly to a home network, the direct home appliance being controlled according to control information received from the home network and transmitting the resulting state information to the home network; at least one indirect home appliance connected indirectly to the home network, the indirect home appliance being controlled according to control information received from the home network and transmitting the resulting state information to the home network; and at least one agent for converting formats of the control information and state information to be transmitted and received between the indirect home appliance and the home network according to standards of the indirect home appliance and home network to connect the indirect home appliance indirectly to the home network, the agent having a plurality of logical identifications (IDs) such that the direct home appliance and the indirect home appliance are interconnected via the home network and construct different networks, respectively.

In accordance with another aspect of the present invention, there is provided a method for networking home appliances through a multinetwork structure, comprising the steps of: a) assigning first and second logical identifications (IDs) to at least one agent, the agent converting formats of control information and state information to be transmitted and received between at least one indirect home appliance and a home network according to standards of the indirect home appliance and home network to connect the indirect home appliance to the home network, the indirect home appliance being incapable of transmitting and receiving the state information and control information directly to/from the home network; b) connecting at least one direct home appliance to the agent using the first logical ID of the agent such that the direct home appliance is connected directly to the home network to transmit and receive control information and state information to/from the home network; and c) connecting the indirect home appliance to the agent using the second logical ID of the agent.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram schematically showing the construction of a conventional home appliance networking system;

FIG. 2 is a view showing a list of constituent elements of a home appliance networking system in accordance with the present invention;

FIG. 3 is a block diagram showing the construction of a preferred embodiment of the home appliance networking system in accordance with the present invention;

FIG. 4 is a block diagram showing the construction of an alternative embodiment of the home appliance networking system in accordance with the present invention; and

FIG. 5 is a flow chart illustrating a home appliance networking method in accordance with the present invention.

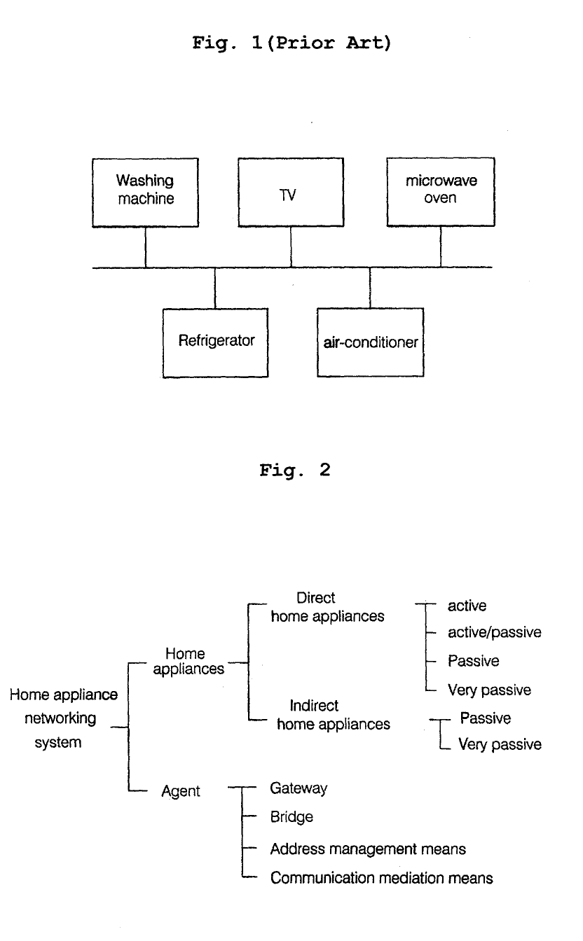

### DESCRIPTION OF THE PREFERRED EMBODIMENTS

FIG. 2 shows a list of constituent elements of a home appliance networking system in accordance with the present invention. As shown in this drawing, the home appliance networking system comprises a plurality of home appliances and an agent. The home appliances are roughly classified into two types, direct home appliances connected directly to a network constructed in a home, and indirect home appliances connected indirectly to the network. The direct home appliances are classified into at least one active direct home appliance which transmits control information to a different home appliance connected to the network, at least one active/passive direct home appliance which transmits control information to a different home appliance connected to the network and is operated according to control information received from a different home appliance connected to the network, at least one very passive direct home appliance which is operated according to control information received from a different home appliance connected to the network, and at least one passive direct home appliance which is operated according to control information received from a different home appliance connected to the network and, in case of occurrence of a failure or emergency, automatically generates state information and transmits the generated state information over the network.

The indirect home appliances are classified into at least one passive indirect home appliance which is operated according to control information received from a different home appliance connected to the network and automatically transmits state information over an external network, and at least one very passive indirect home appliance which is operated according to control information received from a different home appliance connected to the network.

Namely, the home appliances shown in FIG. 2 can be classified as arranged in the below table 1.

TABLE 1

| | | TRANSMIT CONTROL | OPERATED BY RECEIVED | TRANSMIT STATE |
|---|---|---|---|---|
| | | INFORMATION | CONTROL INFORMATION | INFORMATION |
| DIRECT | ACTIVE | O | | |
| HOME | ACTIVE/PASSIVE | O | O | O |
| APPLIANCES | PASSIVE | | O | O |
| | VERY PASSIVE | | O | |
| INDIRECT | PASSIVE | | O | O |
| HOME | VERY PASSIVE | | O | |
| APPLIANCES | | | | |

As also shown in FIG. 2, the agent includes address management means, such as a gateway, bridge, etc., for assigning an address to at least one home appliance connected to the network therethrough such that the home appliance transmits and receives data over the network, and communication mediation means for converting formats of data to be transmitted and received by the home appliance assigned the address according to standards of the home appliance and network and transmitting and receiving the resulting data.

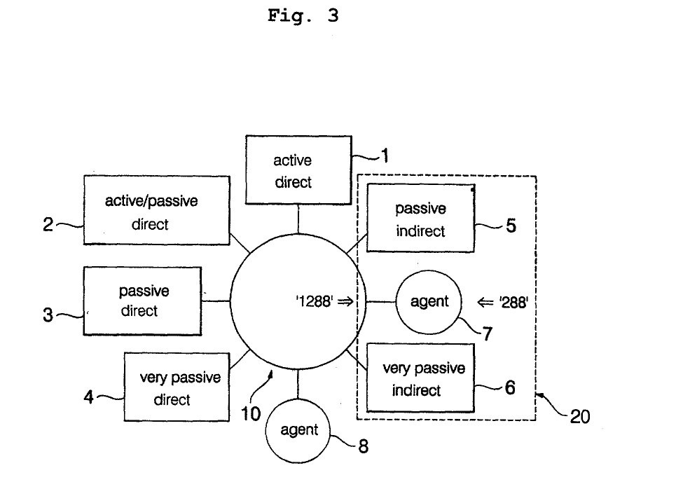

Now, a detailed description will be given of a preferred embodiment of the home appliance networking system in accordance with the present invention with reference to FIG. 3.

As shown in FIG. 3, the home appliance networking system comprises a plurality of direct home appliances 1, 2, 3 and 4 connected directly to a network constructed in a home, a plurality of indirect home appliances 5 and 6 connected indirectly to the network, and at least one agent 7 or 8 assigned first and second logical identifications (IDs). The agent 7 or 8 converts formats of information to be transmitted and received between the indirect home appliances 5 and 6 and the network according to standards of the home appliances and network to connect the home appliances 5 and 6 to the network.

Among the plurality of direct home appliances 1, 2, 3 and 4, the direct home appliance 1 is an active direct home appliance which is connected directly to the network to transmit control information to a different home appliance connected to the network, and the direct home appliance 2 is an active/passive direct home appliance which transmits control information, is controlled according to received external control information, automatically generates the resulting state information as needed and transmits the generated state information. Also, the direct home appliance 3 is a passive direct home appliance which is controlled according to control information received over the network, automatically generates the resulting state information as needed and transmits the generated state information, and the direct home appliance 4 is a very passive direct home appliance which is controlled according to control information received over the network and generates the resulting state information.

Particularly, the plurality of direct home appliances 1, 2, 3 and 4 code/decode information to be transmitted and received to/from the network at coding/decoding levels higher than those of the indirect home appliances 5 and 6 and transmit and receive the coded/decoded information. That is, the direct home appliances 1, 2, 3 and 4 have to transmit and receive control information and state information directly to/from the network, because they are connected directly to the network through no separate agent. For this reason, the direct home appliances 1, 2, 3 and 4 are operated according to algorithms of relatively high coding/decoding levels.

On the other hand, of the plurality of indirect home appliances 5 and 6, the indirect home appliance 5 is a passive indirect home appliance which generates state information regarding occurrence of a failure or emergency therein as needed, transmits the generated state information to the network through the agent 7 or 8, is controlled according to control information received over the network and generates the resulting state information, and the indirect home appliance 6 is a very passive indirect home appliance 6 which is controlled according to control information received over the network and generates the resulting state information, without automatically generating state information as needed.

In particular, each of the indirect home appliances 5 and 6 is assigned an address by address management means of the agent 7 or 8 such that it is connectable to the network. Each of the indirect home appliances 5 and 6 transmits and receives control information and state information to/from the network through communication mediation means of the agent 7 or 8. As a result, the indirect home appliances 5 and 6 are operated according to algorithms of coding/decoding levels lower than those of the direct home appliances 1, 2, 3 and 4.

For example, the direct home appliances 1, 2, 3 and 4 may be a remote controller, audio receiver, safe and so forth which are of relatively great importance to security, are operated according to complex algorithms and control other home appliances, and the indirect home appliances 5 and 6 may be a coffeepot, electric fan, etc. which are simply controlled according to control information received over the network and are of little importance to security.

On the other hand, the agent 7 or 8 has a first logical ID opened to the direct home appliances 1, 2, 3 and 4 such that they transmit and receive information to/from the agent using the first logical ID, and a second logical ID opened to the indirect home appliances 5 and 6 such that they are connected to the network through the agent using the second logical ID.

For example, if the first logical ID of the agent 7 is ‘1288’ and the second logical ID thereof is ‘288’, the direct home appliances 1, 2, 3 and 4 recognize only the first logical ID ‘1288’ of the agent 7 and thus construct a first network 10. Also, the indirect home appliances 5 and 6 recognize only the second logical ID ‘288’ of the agent 7 and thus construct a second network 20.

Here, the agent 7 can assign addresses respectively to the plurality of indirect home appliances 5 and 6 such that they are connected to the network.

Accordingly, the plurality of direct home appliances 1, 2, 3 and 4 and the plurality of indirect home appliances 5 and 6 construct multiple networks such that they are interoperable over the multiple networks. Namely, the plurality of direct home appliances 1, 2, 3 and 4 and the plurality of indirect home appliances 5 and 6 construct the first and second different networks 10 and 20, respectively. In this regard, even though an external intruder intrudes into the second network 20, information of the first network 10 and the plurality of direct home appliances 1, 2, 3 and 4 connected thereto can be prevented from leaking out, because the intruder can recognize only the second logical ID of the agent.

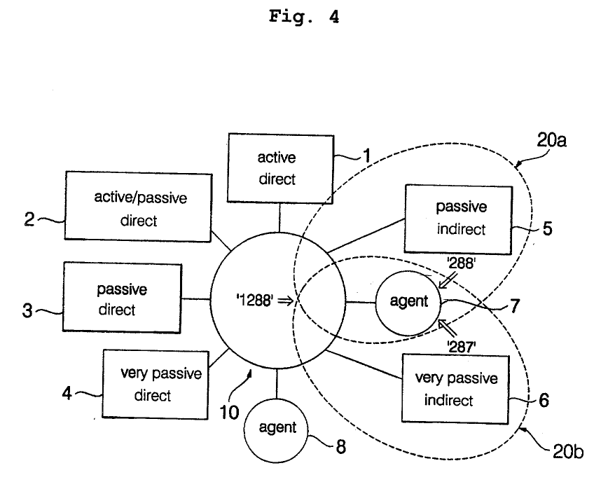

Next, a detailed description will be given of an alternative embodiment of the home appliance networking system in accordance with the present invention with reference to FIG. 4.

In the second embodiment of the present invention, the agent 7 is assigned logical IDs based on the number of the indirect home appliances 5 and 6 connected thereto. That is, in the second embodiment, the agent 7 is connected to the indirect home appliances 5 and 6, respectively, through second different networks 20a and 20b, as well as to the plurality of direct home appliances 1, 2, 3 and 4 through the first network 10.

For example, the agent 7 may have a first logical ID ‘1288’ opened to the direct home appliances 1, 2, 3 and 4, a second logical ID ‘288’ opened to the passive indirect home appliance 5, and a third logical ID ‘287’ opened to the very passive indirect home appliance 6.

As described above, the home appliance networking system according to the second embodiment of the present invention has the three different networks on the basis of the first, second and third logical IDs. Therefore, in the second embodiment, in the case where an intruder intrudes into the second network 20a, he/she cannot recognize information regarding other home appliances connected to the different networks 10 and 20b, differently from the first embodiment wherein the intruder intruding into the second network 20 can recognize information regarding all the indirect home appliances 5 and 6 connected to the second network 20. Consequently, security of information can be maintained at a higher level.

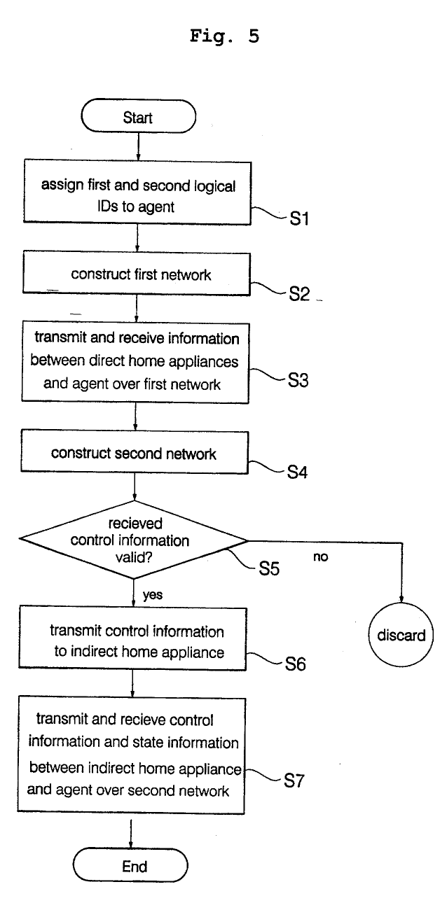

The operation of the first embodiment of the home appliance networking system with the above-stated construction in accordance with the present invention will hereinafter be described in detail with reference to FIG. 5.

At the first step S1, the agent is assigned the first and second logical IDs. As a result, the agent has the first logical ID ‘1288’ opened to the direct home appliances, and the second logical ID ‘288’ opened to the indirect home appliances.

At the second step S2, the direct home appliances are connected to the agent through the first logical ID so as to construct the first network.

At the third step S3, the direct home appliances transmit and receive control information for control of the indirect home appliances and the resulting state information to/from the agent over the first network constructed at the above second step S2.

At the fourth step S4, the indirect home appliances are connected to the agent through the second logical ID so as to construct the second network.

At the fifth step S5, the agent determines whether control information from the direct home appliances received over the second network constructed at the above fourth step S4 is valid. If the received control information is determined not to be valid, the agent discards the control information.

In the case where the received control information is determined to be valid at the above fifth step S5, the agent transmits the control information to a corresponding one of the indirect home appliances at the sixth step S6.

At the seventh step S7, the corresponding indirect home appliance is controlled according to the control information transmitted at the above sixth step S6 and generates the resulting state information. Then, the agent receives the state information generated by the corresponding indirect home appliance and transmits the received state information to the first network over the second network.

As apparent from the above description, the present invention provides a system and method for networking home appliances through a multinetwork structure, wherein the home appliances are connected directly or indirectly to a network constructed through a LAN line or power line communication network in a home such that they are operated according to algorithms of different coding/decoding levels. The home appliances construct different networks so that they are efficiently interoperable in the entire network. Therefore, even though an external intruder intrudes into any one of the different networks, information of home appliances connected to the other networks can be prevented from leaking out, thereby avoiding security risks.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for networking home appliances through a multinetwork structure, comprising:
at least one direct home appliance connected directly to a home network, said direct home appliance being controlled according to control information received from said home network and transmitting the resulting state information to said home network;
at least one indirect home appliance connected indirectly to said home network, said indirect home appliance being controlled according to control information received from said home network and transmitting the resulting state information to said home network; and
at least one agent for converting formats of said control information and state information to be transmitted and received between said indirect home appliance and said home network according to standards of said indirect home appliance and home network to connect said indirect home appliance indirectly to said home network, said agent having a plurality of logical identifications (IDs) such that said direct home appliance and said indirect home appliance are interconnected via said home network and construct different networks, respectively.

2. The system as set forth in claim 1, wherein said direct home appliance is adapted to convert formats of said state information and control information to be transmitted and received to/from said home network according to standards of said direct home appliance and home network, determine whether the received control information is valid and be controlled according to the received control information if it is valid.

3. The system as set forth in claim 1, wherein said agent includes:
address management means for assigning a corresponding one of said logical IDs to said indirect home appliance; and
communication mediation means for converting the formats of said control information and state information to be transmitted and received between said indirect home appliance assigned said corresponding logical ID by said address management means and said home network according to the standards of said indirect home appliance and home network and transmitting said control information received from said home network to said indirect home appliance only when it is valid.

4. The system as set forth in claim 1, wherein said plurality of logical IDs of said agent are:
a first logical ID opened to said direct home appliance such that it is connected to said agent via said home network; and
a second logical ID opened to said indirect home appliance such that it is connected to said home network through said agent.

5. The system as set forth in claim 4, wherein said second logical ID includes a plurality of logical IDs opened respectively to a plurality of indirect home appliances connected to said network through said agent such that said indirect home appliances construct different networks, respectively.

6. The system as set forth in claim 4, wherein said different networks are constructed to transmit and receive data to/from home appliances connected respectively thereto according to different coding/decoding algorithms, respectively.

7. A method for networking home appliances through a multinetwork structure, comprising the steps of:
a) assigning first and second logical identifications (IDs) to at least one agent, said agent converting formats of control information and state information to be transmitted and received between at least one indirect home appliance and a home network according to standards of said indirect home appliance and home network to connect said indirect home appliance to said home network, said indirect home appliance being incapable of transmitting and receiving said state information and control information directly to/from said home network;
b) connecting at least one direct home appliance to said agent using said first logical ID of said agent such that said direct home appliance is connected directly to said home network to transmit and receive control information and state information to/from said home network; and
c) connecting said indirect home appliance to said agent using said second logical ID of said agent.

8. The method as set forth in claim 7, wherein said first logical ID assigned at said step a) is opened to only said direct home appliance, and said second logical ID assigned at said step a) is opened to only said indirect home appliance.

9. The method as set forth in claim 7, wherein said step b) includes the steps of:
b-1) constructing a first network by connecting said direct home appliance to said agent using said first logical ID of said agent; and
b-2) transmitting and receiving control information for said indirect home appliance and the resulting state information of said indirect home appliance between said direct home appliance and said agent over said first network constructed at said step b-1); and
wherein said step c) includes the steps of:
c-1) constructing a second network by connecting said indirect home appliance to said agent using said second logical ID of said agent; and
c-2) transmitting control information received from said agent over said second network constructed at said step c-1) to said indirect home appliance and transmitting the resulting state information of said indirect home appliance to said first network through said agent and over said second network.

10. The method as set forth in claim 7, wherein said second logical ID assigned at said step a) includes a plurality of logical IDs opened respectively to a plurality of indirect home appliances.

11. The method as set forth in claim 10, wherein said step c) includes the step of constructing different networks by connecting said plurality of indirect home appliances to said agent, respectively, using said plurality of logical IDs.
